(19) United States
(12) Patent Application Publication
(10) Pub. No.: US 2026/0173110 A1
(43) Pub. Date: Jun. 18, 2026

(54) METHOD, DEVICE AND COMPUTER READABLE MEDIUM FOR SIDELINK COMMUNICATIONS

(71) Applicant: NEC Corporation, Tokyo (JP)

(72) Inventors: Jin YANG, Beijing (CN); Zhaobang MIAO, Beijing (CN); Gang WANG, Beijing (CN)

(73) Assignee: NEC Corporation, Tokyo (JP)

(21) Appl. No.: 19/126,331

(22) PCT Filed: Nov. 2, 2022
(86) PCT No.: PCT/CN2022/129363

§ 371 Date: May 1, 2025

(51) Int. Cl. H04W 72/25

(52) U.S. Cl. CPC H04W 72/25

(57) ABSTRACT

Embodiments of the present disclosure relate to method, device and computer readable media for sidelink communications. A method for sidelink communications comprises: determining, at a second terminal device, whether to perform second sidelink transmission from a second start point in a slot based on detecting sidelink control information (SCI) transmitted from a first start point in the slot, wherein the second start point is subsequent to the first start point; and if the second sidelink transmission is to be performed, performing the second sidelink transmission from the second start point.

### TECHNICAL FIELD

Embodiments of the present disclosure generally relate to the field of telecommunication, and in particular, to a method, device and computer readable media for sidelink communications.

### BACKGROUND

Sidelink in unlicensed spectrum or band (SL-U) is a key topic in Release 18 of the 3rd Generation Partnership Project (3GPP). SL-U should base on New Radio (NR) sidelink and NR-U.

For SL-U, more than one transmission starting points may be used in a slot, i.e., the first starting point and one or more additional starting points. Terminal devices may access channel and transmit sidelink signals based on different starting points respectively. For sidelink transmission from additional starting points, relevant modification of SL channel structure and transmission schemes need to be studied and specified.

### SUMMARY

In general, example embodiments of the present disclosure provide methods, devices and computer readable media for sidelink communications.

In a first aspect, there is provided a method for sidelink communications. The method comprises: determining, at a second terminal device, whether to perform second sidelink transmission from a second start point in a slot based on detecting sidelink control information (SCI) transmitted from a first start point in the slot, wherein the second start point is subsequent to the first start point; and in accordance with a determination that the second sidelink transmission is to be performed, performing the second sidelink transmission from the second start point.

In a second aspect, there is provided a method for sidelink communications. The method comprises: obtaining, at a first terminal device, a configuration of a second start point in a slot, wherein the second start point is subsequent to a first start point in the slot; and performing, based on the configuration, first sidelink transmission from the first sidelink start point.

In a third aspect, there is provided a terminal device. The terminal device comprises a processor and a memory storing instructions. The memory and the instructions are configured, with the processor, to cause the terminal device to perform the method according to the first aspect.

In a fourth aspect, there is provided a terminal device. The terminal device comprises a processor and a memory storing instructions. The memory and the instructions are configured, with the processor, to cause the terminal device to perform the method according to the second aspect.

In a fifth aspect, there is provided a computer readable medium having instructions stored thereon. The instructions, when executed on at least one processor of a device, cause the device to perform the method according to the first aspect.

In a sixth aspect, there is provided a computer readable medium having instructions stored thereon. The instructions, when executed on at least one processor of a device, cause the device to perform the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2 illustrates an example of a timing resource allocation in a sidelink resource pool in accordance with some embodiments of the present disclosure;

FIG. 3 illustrates an example of a symbol allocation in a sidelink slot in accordance with some embodiments of the present disclosure;

FIG. 4 illustrates an example of a frequency resource allocation in a sidelink resource pool in accordance with some embodiments of the present disclosure;

FIG. 5 illustrates an example of sidelink channels in time domain in accordance with some embodiments of the present disclosure;

FIG. 6 illustrates an example of a symbol allocation in a sidelink subframe in accordance with other embodiments of the present disclosure;

FIG. 7 illustrates an example of feedback channel resources in time domain in accordance with some embodiments of the present disclosure;

FIG. 8 illustrates an example of IRBs in an NR-U IRB scheme in accordance with some embodiments of the present disclosure;

FIG. 9 illustrates a flowchart of an example method in accordance with some embodiments of the present disclosure;

FIGS. 10A and 10B illustrate an example of two starting points in accordance with some embodiments of the present disclosure, respectively;

FIG. 11 illustrates a flowchart of an example method for determining whether to perform the second sidelink transmission from the second start point in accordance with some embodiments of the present disclosure;

FIG. 12 illustrates a flowchart of an example method for determining whether to perform the second sidelink transmission from the second start point in accordance with some other embodiments of the present disclosure;

FIG. 13 illustrates a flowchart of an example method for determining whether to perform the second sidelink transmission from the second start point in accordance with some other embodiments of the present disclosure;

FIG. 14A illustrates an example of a symbol repetition for the second start symbol in accordance with some embodiments of the present disclosure;

FIG. 14B illustrates an example of an extension signal for the second start symbol in accordance with some embodiments of the present disclosure;

FIGS. 15A and 15B illustrate an example of a PSCCH resource associated with the second start point in accordance with some embodiments of the present disclosure, respectively;

FIGS. 16A, 16B, 16C and 16D illustrate an example of a symbol repetition for the second start symbol in accordance with some embodiments of the present disclosure, respectively;

FIG. 17 illustrates a flowchart of an example method in accordance with other embodiments of the present disclosure;

FIG. 18 illustrates a flowchart of an example method in accordance with other embodiments of the present disclosure; and

FIG. 19 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organizing Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

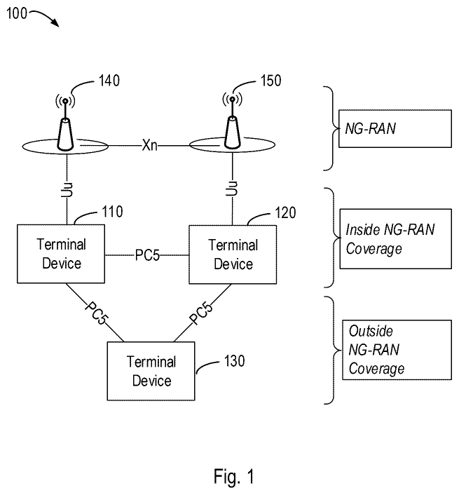

FIG. 1 illustrates a schematic diagram of an example communication network 100 in which embodiments of the present disclosure can be implemented. As shown in FIG. 1, the communication network 100 may include a first terminal device 110, a second terminal device 120, a third terminal device 130, network devices 140 and 150. The network devices 140 and 150 may communicate with the terminal device 110, the terminal device 120 and the terminal device 130 via respective wireless communication channels.

In some embodiments, the network device 140 may be a gNB in NR. Thus, the network device 140 may be also referred to as an NR network device 140.

In some embodiments, the network device 150 may be an eNB in Long Term Evolution (LTE) system. Thus, the network device 150 may be also referred to as an LTE network device 150.

It is to be understood that the number of devices in FIG. 1 is given for the purpose of illustration without suggesting any limitations to the present disclosure. The communication network 100 may include any suitable number of network devices and/or terminal devices adapted for implementing embodiments of the present disclosure.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the communications in the communication network 100 may comprise sidelink communication. Sidelink communication is a wireless radio communication directly between two or more terminal devices, such as two or more terminal devices among the terminal device 110, the terminal device 120 and the terminal device 130. In this type of communication, the two or more terminal devices that are geographically proximate to each other can directly communicate without going through the network device 140 or 150 or through a core network. Data transmission in sidelink communication is thus different from typical cellular network communications, in which a terminal device transmits data to the network device 140 or 150 (i.e., uplink transmissions) or receives data from the network device 140 or 150 (i.e., downlink transmissions). In sidelink communication, data is transmitted directly from a source terminal device (such as the terminal device 110) to a target terminal device (such as the terminal device 120) through the Unified Air Interface, e.g., PC5 interface, (i.e., sidelink transmissions), as shown in FIG. 1.

Sidelink communication can provide several advantages, including reducing data transmission load on a core network, system resource consumption, transmission power consumption, and network operation costs, saving wireless spectrum resources, and increasing spectrum efficiency of a cellular wireless communication system.

In a sidelink communication system, the sidelink resource is used to transmit information between terminal devices. According to application scenarios, service types, etc., a sidelink communication manner includes but is not limited to device to device (D2D) communication, Vehicle-to-Everything (V2X) communication, etc.

V2X communication enables vehicles to communicate with other vehicles (i.e. Vehicle-to-Vehicle (V2V) communication), with infrastructure (i.e. Vehicle-to-Infrastructure (V2I), with wireless networks (i.e. Vehicle-to-Network (V2N) communication), with pedestrians (i.e. Vehicle-to-Pedestrian (V2P) communication), and even with the owner's home (i.e. Vehicle-to-Home (V2H)). Examples of infrastructure include roadside units such as traffic lights, toll gates and the like. V2X communication can be used in a wide range of scenarios, including in accident prevention and safety, convenience, traffic efficiency and clean driving, and ultimately in relation to autonomous or self-driving vehicles.

For sidelink communications, a terminal device uses resources in sidelink resource pools to transmit or receive signals. The sidelink resource pools include resources in time domain and frequency domain, which are dedicated resources of the sidelink communication, or shared by the sidelink communication and a cellular link. For sidelink communications, two modes of resource assignment may be used for sidelink, including network device schedules sidelink resources for terminal devices to perform sidelink signal transmission, named as mode 1 resource scheme in NR sidelink or mode 3 resource scheme in LTE sidelink, and terminal device selects sidelink resources by itself to perform sidelink signal transmission, named as mode 2 resource scheme in NR sidelink or mode 4 resource scheme in LTE sidelink.

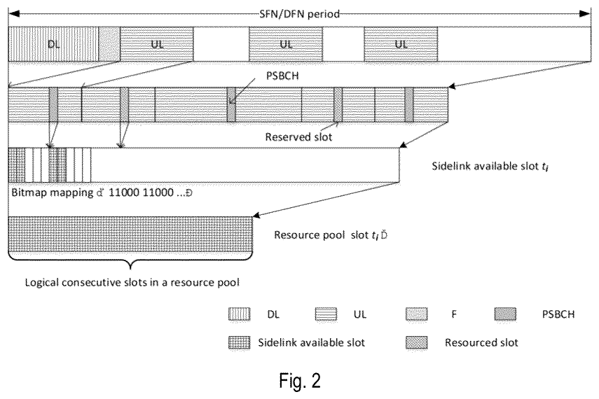

FIG. 2 illustrates an example of a timing resource allocation in a sidelink resource pool in accordance with some embodiments of the present disclosure. In some embodiments, the sidelink resource pool may comprise an NR sidelink resource pool. In such embodiments, the sidelink resource pool may be defined within a sidelink bandwidth part (BWP). The terminal device 110, the terminal device 120 and the terminal device 130 may use uplink (UL) resources for sidelink communications. More than one sidelink resource pools may be configured for one of the terminal device 110, the terminal device 120 and the terminal device 130. A dedicated resource pool may be used for mode 1 resource scheme or mode 2 resource scheme, short for mode 1 resource pool or mode 2 resource pool. For LTE sidelink, a dedicated resource pool may be used for mode 3 resource scheme or mode 4 resource scheme, short for mode 3 resource pool or mode 4 resource pool. Resources within the sidelink resource pool may comprise Physical Sidelink Control Channel (PSCCH) resources, Physical Sidelink Shared Channel (PSSCH) resources and physical sidelink feedback channel (PSFCH) resources. A bitmap may be used to indicate which UL slots are configured as sidelink slots. A length of the bitmap may be in a range of 10 to 160.

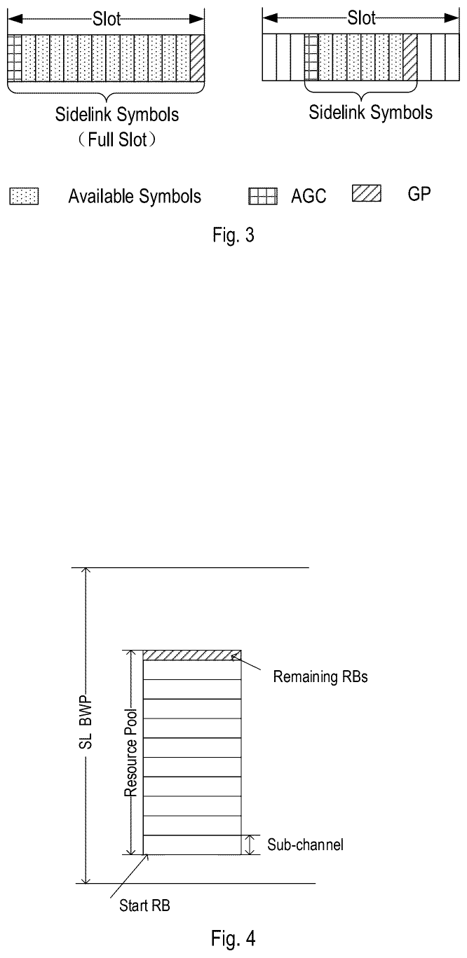

FIG. 3 illustrates an example of a symbol allocation in a sidelink slot in accordance with some embodiments of the present disclosure. In the sidelink resource pool which may contain multiple slots and resource blocks (RBs), and all or part of the symbols in a slot can be used for sidelink transmission. Within the resource pool, among all the symbols configured for sidelink in each slot, the first symbol (i.e., the start symbol) is used as the automatic gain control (AGC) symbol, and the last symbol used as a guard period (GP) symbol. AGC symbols and GP symbols can be considered as fixed overheads in sidelink resource. In the description of the following embodiments, AGC symbols and GP symbols are included in the sidelink symbols which are indicated by the sidelink channel resource configuration, and AGC symbols carry redundancy sidelink information while GP symbols are not used for carrying sidelink information, as shown in FIG. 3.

The terminal device 110, the terminal device 120 and the terminal device 130 may use sidelink channels to transmit sidelink signaling or information. The sidelink channels include at least one of the following: a PSCCH resource which is used for carrying sidelink control information (SCI), a PSSCH resource which is used for carrying sidelink data service information, a PSFCH resource which is used for carrying sidelink Hybrid Automatic Repeat Request (HARQ) feedback information, a physical sidelink broadcast channel (PSBCH) resource which is used for carrying sidelink broadcast information, and a physical sidelink discovery channel (PSDCH) resource which is used for carrying a sidelink discovery signal.

FIG. 4 illustrates an example of a frequency resource allocation in a sidelink resource pool in accordance with some embodiments of the present disclosure. In some embodiments, the sidelink resource pool may be an NR sidelink resource pool. As shown in FIG. 4, the sidelink resource pool may be configured within a SL Bandwidth Part (Sidelink BWP). A resource pool configuration may comprise sl-StartRB-Subchannel and sl-RB-Number. The sl-StartRB-Subchannel may indicate the lowest Resource Block (RB) of the resource pool. The lowest RB is also referred to as a start RB. The sl-RB-Number may indicate the total number of RBs of the resource pool.

RBs in the resource pool may be divided into consecutive sub-channels. Sub-channel is a frequency resource unit of PSSCH. Each sub-channel contains consecutive RBs.

The terminal devices 110, 120 and 130 may use one or more consecutive sub-channels as a PSSCH resource to transmit sidelink data. A sub-channel configuration of the resource pool may comprise sl-SubchannelSize which indicates the number of RBs contained in one sub-channel. The SubchannelSize may be equal to 10, 12, 15, 20, 25, 50, 75 or 100.

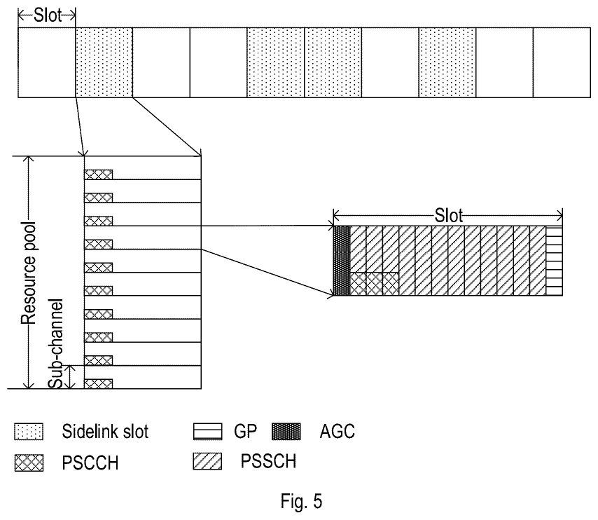

FIG. 5 illustrates an example of sidelink channels in time domain in accordance with some embodiments of the present disclosure. In the example of FIG. 5, the sidelink channels comprise PSCCH and PSSCH. PSCCH may carry SCI format 1. One PSCCH may be defined within each sub-channel. Each PSCCH resource may include t consecutive symbols in time domain and k consecutive RBs in frequency domain. The t symbols start from the first symbol in the available symbols in the time domain, where t=2 or 3. The k RBs start from the first RB in the corresponding sub-channel, where k=10, 12, 15, 20, or 25. PSSCH may carry SCI format 2A/2B and sidelink data PSSCH uses sub-channel as a frequency unit. The terminal devices 110, 120 and 130 may use one or more consecutive sub-channels as a PSSCH resource to transmit sidelink data.

Similar to the NR sidelink resource pool, within an LTE sidelink resource pool, the terminal device 110, the terminal device 120 or the terminal device 130 may use uplink (UL) resources for sidelink communications. More than one sidelink resource pools may be configured for the terminal device 110, the terminal device 120 or the terminal device 130. Resources within the LTE sidelink resource pool may comprise a PSCCH resource pool and a PSSCH resource pool. A bitmap may be used to indicate which UL subframes are configured as sidelink subframes.

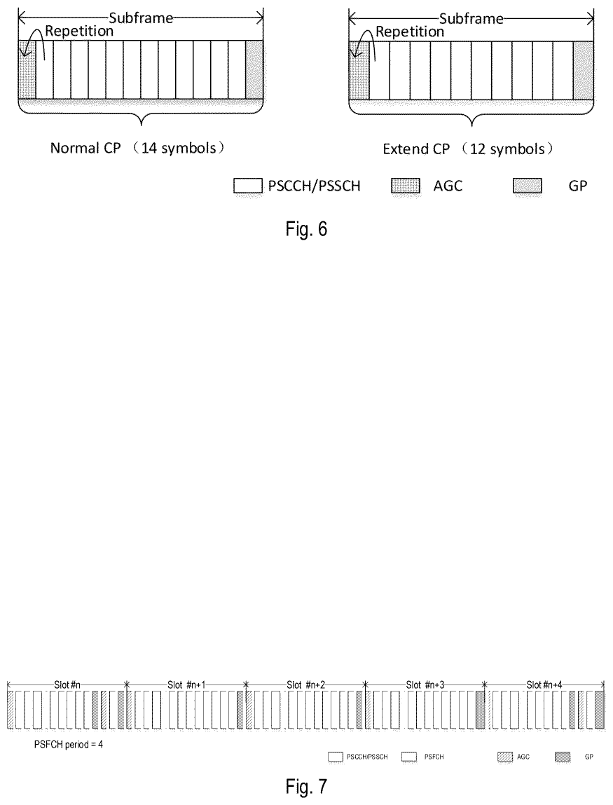

FIG. 6 illustrates an example of a symbol allocation in a sidelink subframe in accordance with other embodiments of the present disclosure. In some embodiments, sidelink subframes in FIG. 6 may be LTE sidelink subframes. As shown in FIG. 6, all symbols in a subframe are used as sidelink resource. In a subframe, the first symbol is used as AGC and the last symbol is used as GP.

LTE sidelink channels may comprise PSCCH and PSSCH. PSCCH may carry SCI format 1. One PSCCH is associated with one sub-channel. Each PSCCH resource has a fixed size. For example, each PSCCH resource may comprise two consecutive PRBs and all symbols in a sidelink subframe. PSSCH may carry sidelink data and use sub-channel as frequency unit. The terminal device 110, the terminal device 120 or the terminal device 130 may use one or more consecutive sub-channels as PSSCH resource to transmit sidelink data. Relationship between PSCCH and PSSCH may be one-to-one mapping.

Within a resource pool, whether a PSFCH resource is available should be configured or pre-configured. In time domain, according to the configuration or pre-configuration of a resource pool, one of every N slots in the resource pool contains PSFCH resources, N=[0,1,2,4]. In a sidelink resource pool, PSCCH or PSSCH resources are presented in every slot and used for transmitting sidelink data packet. Within a slot containing a PSFCH resource, the last three SL symbols (AGC+PSFCH+GP) are used for PSFCH related, as shown in FIG. 7.

A PSFCH resource may comprises one RB in frequency domain and one symbol in time domain (AGC symbol is repeated). In addition, the PSFCH resource may carry 1 bit ACK/NACK information. Furthermore, the PSFCH resource may be related to one sub-channel in one slot.

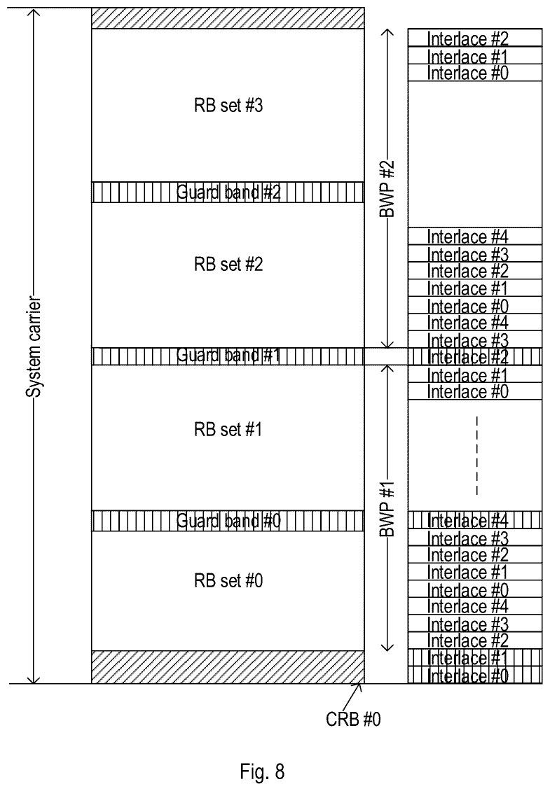

IRB is used as a frequency resource unit for NR-U uplink. FIG. 8 illustrates an example of an RB set and IRB in an NR-U IRB scheme in accordance with some embodiments of the present disclosure. As shown in FIG. 8, each of the RB sets may be defined as 20 MHz. For Subcarrier Spacing (SCS) of 15 kHz, each of the RB sets may comprises 100 to 110 RBs. For SCS of 30 kHz, each of the RB sets may comprises 50 to 55 RBs. There may be a guard band between two adjacent RB sets.

BWPs #1 and #2 are defined within a system carrier. The BWP #1 comprises RB sets #0 and #1. The BWP #2 comprises RB sets #2 and #3. It will be understood that although it is shown in FIG. 8 that each of BWPs comprises a plurality of RB sets, in some embodiments, one or more of the BWPs may comprise a single RB set.

In the present disclosure, terms “IRB” and “interlace” may be used interchangeably. IRBs or interlaces are defined within a system carrier. An IRB with an index 0 starts from a Common Resource Block (CRB) with an index 0 (i.e., CRB #0). For SCS of 30 kHz, 5 interlaces may be defined within the system carrier, as shown in FIG. 8. For SCS of 15 kHz, 10 interlaces may be defined within the system carrier.

For SL-U, a terminal device may access channel by using a channel access procedure, and then transmit sidelink signal if the channel access procedure succeeds. Once the terminal device transmits on the channel, other terminal devices would identify the channel as occupied and cannot perform transmission. For the case that the terminal device transmits signal on the channel with only on a part of frequency domain resources, the remaining frequency resources may be wasted which may reduce the resource efficiency.

In order to solve the above and other potential problems, embodiments of the present disclosure provide a solution for sidelink communications. In the solution, a second terminal device determines whether to perform second sidelink transmission from a second start point in a slot based on detecting SCI transmitted from a first start point in the slot, wherein the second start point is subsequent to the first start point. If the second sidelink transmission is to be performed, the second terminal device performs the second sidelink transmission from the second start point. In this way, sidelink communication efficiency and channel access success rate may be improved.

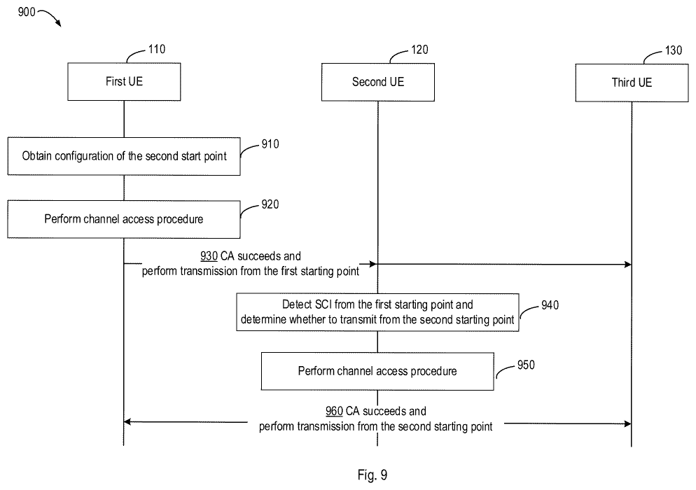

Hereinafter, some embodiments of the present disclosure according to the first aspect will be described with reference to FIGS. 9 to 18.

Procedure of Terminal Devices Transmission from any Starting Points

FIG. 9 illustrates a signaling chart illustrating a process 900 for sidelink communications in accordance with some implementations of the present disclosure. For the purpose of discussion, the process 900 will be described with reference to FIG. 1. The process 900 may involve the first terminal device 110, the second terminal device 120 and the third terminal device 130 as illustrated in FIG. 1. Although the process 900 will be described in the communication network 100 of FIG. 1, this process may be likewise applied to other communication scenarios.

In some embodiments, more than one starting points may be configured or pre-configured for sidelink transmissions in a slot. An initial point in the slot may be named as a first starting point, and others may be named as additional starting points. The additional starting points are subsequent to the first starting point. The additional starting points may be referred to as second starting points. Hereinafter, one of the second starting points will be described by way of example. It shall be understood that more than one second starting points may be applied to the present disclosure.

In some embodiments, the first starting point is defined in the sidelink communication system as the first sidelink symbol in a slot, the second starting point is defined in the sidelink communication system as symbol #s in a slot, #s is fixed. In other words, the symbol location of the first starting point or the second starting point is predefined, and no configuration or indication signaling for the starting points is needed.

As shown in FIG. 9, the first terminal device 110 obtains 910 a configuration of the second start point in the slot. The second start point is subsequent to the first start point in the slot.

The first terminal device 110 performs, based on the configuration, first sidelink transmission from the first sidelink start point.

In some embodiments, the configuration may comprise at least one of the following:
a symbol index of the second start point,
a symbol offset between the first start point and the second start point,
a first indication indicating whether the second start point is enabled,
a second indication indicating whether a symbol repetition for the second start point is enabled,
a third indication that the second start point is not used in the slot which comprises a PSFCH resource,
a priority threshold associated with the second start point,
a Channel Access Priority Class (CAPC) threshold associated with the second start point,
a first ratio threshold associated with the second start point,
a second ratio threshold associated with the second start point,
a third ratio threshold associated with the second start point,
a duration of an extension signal associated with the second start point, or
a first number of consecutive symbols in the slot for transmission of second SCI by the second terminal device 120.

In order to perform the first sidelink transmission, the first terminal device 110 performs 920 a channel access (CA) procedure. When the CA procedure proceeds, the first terminal device 110 performs 930 the first sidelink transmission from the first starting point. From the first starting point, the first terminal device 110 may transmit SCI on PSCCH and sidelink data on PSSCH. For example, the first terminal device 110 may broadcast the SCI and the sidelink data so that the second terminal device 120 and the third terminal device 130 may receive the SCI and the data.

On the other hand, if the CA procedure fails, the first terminal device 110 drops the first sidelink transmission.

The second terminal device 120 detects 940 the SCI transmitted from the first starting point and determines whether to perform second sidelink transmission from the second start point based on detecting the SCI.

In some embodiments, the second terminal device 110 may determine whether to perform second sidelink transmission from the second start point based on detecting the SCI and on the configuration of the second start point.

If the second sidelink transmission is determined to be performed, the second terminal device 120 performs the second sidelink transmission from the second start point.

Specifically, the second terminal device 120 performs 950 a CA procedure. When the CA procedure proceeds, the second terminal device 120 performs 960 the second sidelink transmission from the second starting point. From the second starting point, the second terminal device 120 may transmit second SCI on PSCCH and sidelink data on PSSCH. For example, the second terminal device 120 may broadcast the second SCI and the sidelink data so that the first terminal device 110 and the third terminal device 130 may receive the second SCI and the data.

On the other hand, if the CA procedure fails, the second terminal device 120 drops the second sidelink transmission.

It shall be understood that if the second terminal device 120 determines that the second sidelink transmission is to be performed, the second terminal device 120 may drop to receive signal of the first terminal device 110, and then switch to transmission mode. Then, the second terminal device 120 performs the second sidelink transmission from the second starting point.

With the process 900, sidelink communication efficiency and channel access success rate may be improved. In addition, there is no impact on sidelink HARQ feedback.

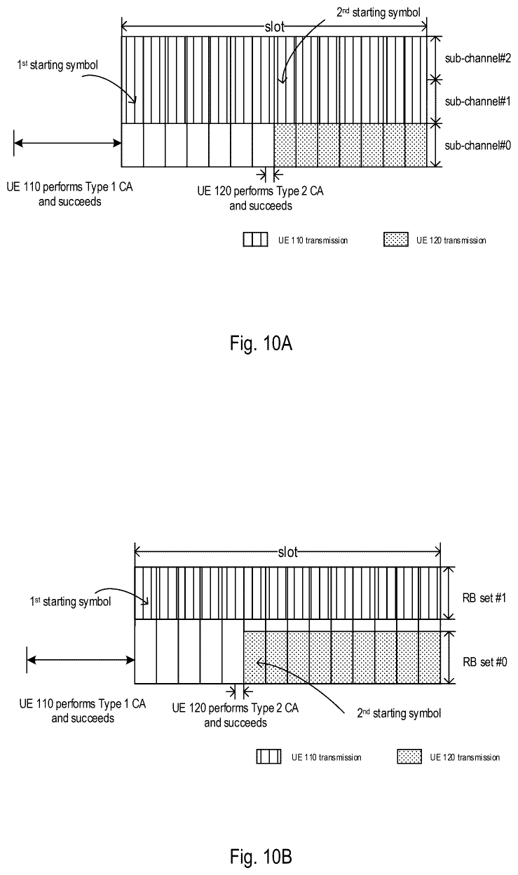

FIGS. 10A and 10B illustrate an example of two starting points in accordance with some embodiments of the present disclosure, respectively. In the examples of FIGS. 10A and 10B, for brevity, the first terminal device 110 is also referred to as first UE 110, and the second terminal device 110 is also referred to as second UE 120.

In the example of FIG. 10A, two starting points are configured in a slot for sidelink communications. A symbol is used as the unit of a starting point. The first starting point is symbol #0 in a slot, and the second starting point is symbol #7 in the slot.

According to sidelink grant on unlicensed spectrum, the first terminal device 110 performs Type 1 CA procedure to occupy the channel. When the Type 1 CA procedure succeeds, the first terminal device 110 performs the first sidelink transmission from the first starting symbol in the slot using sub-channels #1 and #2. For example, the first terminal device 110 transmits SCI on PSCCH using sub-channel #1, and sidelink data on PSSCH using sub-channels #1 and #2.

On the other hand, if the CA procedure fails, the first terminal device 110 drops the first sidelink transmission.

The second terminal device 120 detect the SCI of the first terminal device 110, and identifies that sub-channel #0 is not used by the first terminal device 110. Thus, the second terminal device 120 determines to perform the second sidelink transmission from the second starting point.

Optionally, if the second terminal device 120 determines that the second sidelink transmission is to be performed, the second terminal device 120 may switch from receiving mode to transmitting mode.

Optionally, the second terminal device 120 may perform Type 2 CA procedure to occupy the channel.

When the Type 2 CA procedure succeeds, the second terminal device 120 performs the second sidelink transmission from the second starting symbol in the same slot using sub-channel #0.

On the other hand, if the CA procedure fails, the second terminal device 120 drops the second sidelink transmission.

The example of FIG. 10B is similar to the example of FIG. 10A. The example of FIG. 10B is different from the example of FIG. 10A in that the second starting point is symbol #5 and a sidelink resource pool contains two RB sets in frequency domain.

When the Type 1 CA procedure succeeds, the first terminal device 110 performs the first sidelink transmission from the first starting symbol in a slot using sub-channels in RB set #1.

The second terminal device 120 detects SCI of the first terminal device 110, and identified resources of RB set #0 are not used by the first terminal device 110. Then, the second terminal device 120 determines to perform the second sidelink transmission from the second starting point.

Specifically, the second terminal device 120 performs Type 2 CA procedure and Type 2 CA procedure succeeds. In turn, the second terminal device 120 performs the second sidelink transmission from the second starting symbol in the same slot using sub-channels in RB set #0.

It shall be noted that the second starting symbol should be allocated with symbol index (equal to) larger than #4. Considering the processing time of decoding the SCI from the first terminal device 110, it should not be allocated ahead than symbols used for PSCCH.

Determining Whether to Perform Second Sidelink Transmission from the Second Start Point

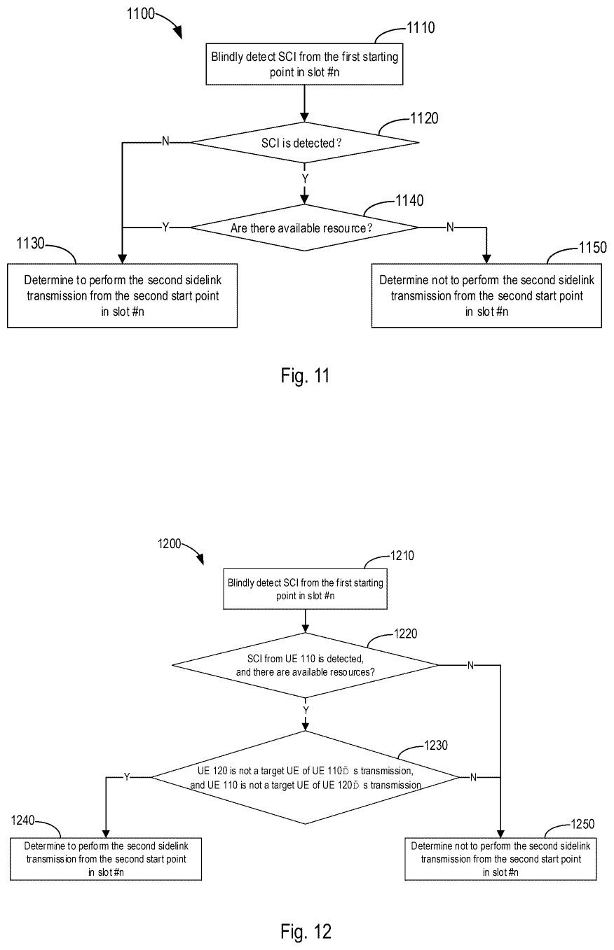

FIG. 11 illustrates a flowchart of an example method 1100 for determining whether to perform the second sidelink transmission from the second start point in accordance with some embodiments of the present disclosure. The method 1100 can be implemented at a terminal device, such as one of the first terminal device 110, the second terminal device 120 and the third terminal device 130 as shown in FIG. 1. For the purpose of discussion, the method 1100 will be described with reference to FIG. 1 as performed by the second terminal device 120 without loss of generality.

Generally, in the method 1100, the second terminal device 120 may determine whether to perform the second sidelink transmission from the second start point according to SCI detection and information indicated in SCI.

In the method 1100, the first starting point and the second starting point may be configured or pre-configured for sidelink transmissions in slot #n.

At block 1110, the second terminal device 120 blindly detects SCI from the first starting point in slot #n.

At block 1120, the second terminal device 120 determines whether the SCI from the first starting point is detected.

If the SCI transmitted from the first start point is not detected, the second terminal device 120 may determine, at block 1130, to perform the second sidelink transmission from the second start point in slot #n.

On the other hand, if at least one of the SCI transmitted from the first start point is detected at block 1120, the second terminal device 120 determines, at block 1140, whether there are available resources in frequency domain in a sidelink resource pool based on the at least one of the SCI.

For example, the available resources in frequency domain may comprise at least one of the following: sub-channels, IRBs, RB sets, or RBs.

If there are the available resources in frequency domain, the second terminal device 120 may determine, at block 1130, to perform the second sidelink transmission from the second start point in slot #n.

On the other hand, if there are not the available resources in frequency domain, the second terminal device 120 may determine, at block 1150, not to perform the second sidelink transmission from the second start point in slot #n.

FIG. 12 illustrates a flowchart of an example method 1200 for determining whether to perform the second sidelink transmission from the second start point in accordance with some other embodiments of the present disclosure. The method 1200 can be implemented at a terminal device, such as one of the first terminal device 110, the second terminal device 120 and the third terminal device 130 as shown in FIG. 1. For the purpose of discussion, the method 1200 will be described with reference to FIG. 1 as performed by the second terminal device 120 without loss of generality.

In the method 1200, the first starting point and the second starting point may be configured or pre-configured for sidelink transmissions in slot #n. For brevity, the first terminal device 110 is also referred to as first UE 110, and the second terminal device 120 is also referred to as second UE 120.

At block 1210, the second terminal device 120 blindly detects SCI from the first starting point in slot #n.

At block 1220, the second terminal device 120 determines whether the SCI from the first starting point is detected and whether there are available resources in frequency domain in a sidelink resource pool based on at least one of the SCI.

If the SCI from the first starting point is detected and there are the available resources in frequency domain, the second terminal device 120 determines, at block 1230, whether the second terminal device 120 is not a target receiving device of first sidelink transmission from the first terminal device 110, and whether the first terminal device 110 is not a target receiving device of the second sidelink transmission from the second terminal device 120.

If the second terminal device 120 is not the target receiving device of the first sidelink transmission from the first terminal device 110, and the first terminal device 110 is not the target receiving device of the second sidelink transmission from the second terminal device 120, the second terminal device 120 may determine, at block 1240, to perform the second sidelink transmission on at least one of the available resources from the second start point.

On the other hand, if the second terminal device 120 determines, at block 1220, that the SCI from the first starting point is not detected and/or there are not available resources in frequency domain, the second terminal device 120 may determine, at block 1250, not to perform the second sidelink transmission on at least one of the available resources from the second start point.

In addition, if the second terminal device 120 determines, at block 1230, that the second terminal device 120 is the target receiving device of the first sidelink transmission or the first terminal device 110 is the target receiving device of the second sidelink transmission, the second terminal device 120 may determine, at block 1250, not to perform the second sidelink transmission on at least one of the available resources from the second start point.

The method 1200 may avoid impact on transmission of the first terminal device 110 as well as impact on the transmission of the second terminal device 120.

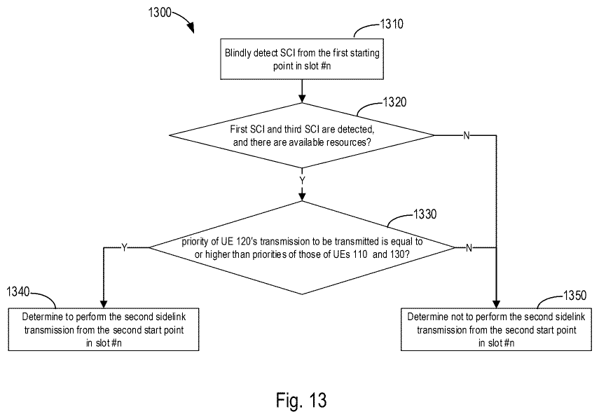

FIG. 13 illustrates a flowchart of an example method 1300 for determining whether to perform the second sidelink transmission from the second start point in accordance with some other embodiments of the present disclosure. The method 1300 can be implemented at a terminal device, such as one of the first terminal device 110, the second terminal device 120 and the third terminal device 130 as shown in FIG. 1. For the purpose of discussion, the method 1300 will be described with reference to FIG. 1 as performed by the second terminal device 120 without loss of generality.

In the method 1300, the first starting point and the second starting point may be configured or pre-configured for sidelink transmissions in slot #n. For brevity, the first terminal device 110 is also referred to as first UE 110, the second terminal device 110 is also referred to as second UE 120, and the third terminal device 130 is also referred to as third UE 130.

At block 1310, the second terminal device 120 blindly detects SCI from the first starting point in slot #n.

At block 1320, the second terminal device 120 determines whether first SCI transmitted by the first terminal device 110 from the first starting point and third SCI transmitted by the third terminal device 130 from the first starting point are detected and whether there are available resources in frequency domain in a sidelink resource pool based on at least one of the SCI.

In some embodiments, the first SCI may indicate a first priority of the first sidelink transmission from the first terminal device 110.

In some embodiments, the third SCI may indicate a third priority of the third sidelink transmission from the third terminal device 130.

If the first SCI and the third SCI from the first starting point are detected and there are the available resources in frequency domain, the second terminal device 120 determines, at block 1330, whether a second priority of the second sidelink transmission is equal to or higher than the first priority and whether the second priority is equal to or higher than the third priority.

If the second priority is equal to or higher than the first priority and the second priority is equal to or higher than the third priority, the second terminal device 120 may determine, at block 1340, to perform the second sidelink transmission on at least one of the available resources from the second start point.

On the other hand, if the second terminal device 120 determines, at block 1330, that the second priority is lower than the first priority and/or the second priority is lower than the third priority, the second terminal device 120 may determine, at block 1350, not to perform the second sidelink transmission on at least one of the available resources from the second start point.

In addition, if the second terminal device 120 determines, at block 1320, that the first SCI and the third SCI from the first starting point are not detected and/or there are not the available resources in frequency domain, the second terminal device 120 may determine, at block 1350, not to perform the second sidelink transmission on at least one of the available resources from the second start point.

The method 1300 may ensure sidelink transmission of higher priority.

In some embodiments, if the second priority of the second sidelink transmission is equal to or higher than a priority threshold, the second terminal device 120 may determine to perform the second sidelink transmission on the at least one of the available resources from the second start point.

In some embodiments, if a first ratio is equal to or higher than a first ratio threshold, the second terminal device 120 may determine to perform the second sidelink transmission on the at least one of the available resources from the second start point. The first ratio is equal to the number of the available resources divided by the number of resources in frequency domain in the sidelink resource pool. For example, the first ratio threshold may be equal to 20%. Such embodiments may be more flexibility to control the transmission on the additional starting points.

In some embodiments, if a second ratio is equal to or higher than a second ratio threshold, the second terminal device 120 may determine to perform the second sidelink transmission on the at least one of the available resources from the second start point. The second ratio is equal to the number of the available resources divided by the number of occupied resources in frequency domain in the sidelink resource pool. Such embodiments may be more flexibility to control the transmission on the additional starting points.

In some embodiments, if a third ratio is equal to or less than a third ratio threshold, the second terminal device 120 may determine to perform the second sidelink transmission on the at least one of the available resources from the second start point. The third ratio is equal to the number of the occupied resources divided by the number of resources in frequency domain in the sidelink resource pool. Such embodiments may be more flexibility to control the transmission on the additional starting points.

In some embodiments, first SCI among the at least one of the SCI comprises a first indication indicating whether the second start point is enabled. In such embodiments, if the first indication indicates that the second start point is enabled, the second terminal device 120 may determine to perform the second sidelink transmission on the at least one of the available resources from the second start point. This may ensure sidelink transmission of higher priority.

In some embodiments, the first SCI may use SCI format 1-B. The SCI format 1-B may comprise an “additional starting symbol enable” indicator (i.e., the first indication) as shown in Table 1.

TABLE 1

| SCI content | indicator |
|---|---|
| additional starting symbol enable | “1” |
| (i.e., the first indication) | |

As shown in Table 1, the overhead of the “additional starting symbol enable” indicator is 1 bit. If the “additional starting symbol enable” indicator is set to “1”, an additional starting symbol can be used by other terminal devices. If the “additional starting symbol enable” indicator is set to “0”, no sidelink transmission is allowed from the additional starting symbol (i.e., the second starting symbol) in the slot.

Operation of the Second Terminal Device which Transmits from an Additional Starting Point

As mentioned above, in some embodiments, the second start point is a second start symbol in the slot. In such embodiments, the second terminal device 120 may perform a symbol repetition for the second start symbol.

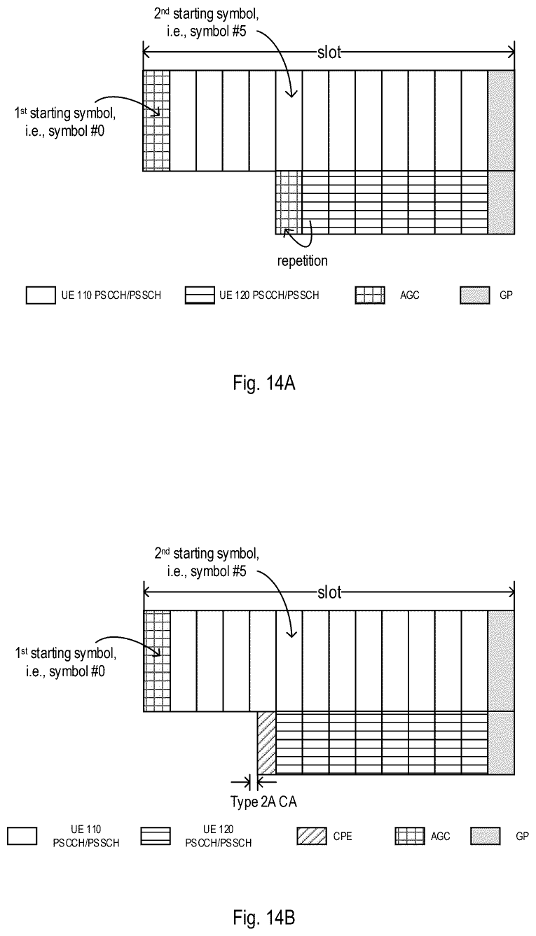

In some embodiments, in order to perform the symbol repetition for the second start symbol, the second terminal device 120 may repeat a signal on a fourth symbol immediately after the second start symbol to the second start symbol. In case where the second start symbol is a symbol #n and the fourth symbol is a symbol #n+1, the second terminal device 120 may repeat a signal on the symbol #n+1 to the symbol #n. To “repeat” means that the resource elements used for the PSCCH/PSSCH of the second terminal device 120 on the symbol #n+1, including any DM-RS, PT-RS, or CSI-RS occurring on symbol #n+1, shall be duplicated on the immediately preceding symbol #n. This will be described with reference to FIG. 14A.

FIG. 14A illustrates an example of a symbol repetition for the second start symbol in accordance with some embodiments of the present disclosure. In the example of FIG. 14A, two starting symbols are configured or pre-configured in a slot. The first starting symbol is a symbol #0. The second starting symbol is a symbol #5.

The second terminal device 120 determines to transmit from the second starting symbol, i.e., symbol #5. The second terminal device 120 uses the second starting symbol as an AGC symbol. That is, the second terminal device 120 repeats a signal on a symbol #6 to the symbol #5, including PSCCH and PSSCH.

In some embodiments, in order to perform the symbol repetition for the second start symbol, the second terminal device 120 may repeat a signal on the second start symbol to a third symbol immediately before the second start symbol. In case where the second start symbol is a symbol #n and the third symbol is a symbol #n−1, the second terminal device 120 may repeat a signal on the symbol #n to the symbol #n−1. To “repeat” means that the resource elements used for the PSCCH/PSSCH of the second terminal device 120 on the symbol #n, including any DM-RS, PT-RS, or CSI-RS occurring on symbol #n, shall be duplicated on the immediately preceding symbol #n−1.

In some embodiments, in order to perform the second sidelink transmission from the second start point, the second terminal device 120 may transmit an extension signal on a third symbol immediately before the second start symbol. This will be described with reference to FIG. 14B.

FIG. 14B illustrates an example of an extension signal for the second start symbol in accordance with some embodiments of the present disclosure. In the example of FIG. 14B, two starting symbols are configured or pre-configured in a slot. The first starting symbol is a symbol #0. The second starting symbol is a symbol #5.

The second terminal device 120 may try to perform Type 2A CA procedure to access channel before the second starting symbol, i.e., symbol #5. If the CA succeeds, the second terminal device 120 performs the second sidelink transmission from the symbol #5 with a Cyclic Prefix Extension (CPE) signal. A duration of the CPE signal is equal to (symbol length-25 us).

If the CA procedure fails, the second terminal device 120 drops the second sidelink transmission.

In some embodiments, the second terminal device 120 may determine the duration of the extension signal based on at least one of the following:
a configuration,
a pre-configuration,
a type of a channel access procedure used by the second terminal device 120,
a duration of the second start symbol, or
a time gap related to the channel access procedure.

In some embodiments, the second terminal device 120 may transmit second SCI on a PSCCH resource associated with the second start point.

In some embodiments, the PSCCH resource comprises a first number of consecutive symbols in the slot. The first number of consecutive symbols may start from the second start point. Alternatively, the first number of consecutive symbols may start from a fourth symbol immediately after the second start point. Hereinafter, the first number may be represented by m.

In some embodiments, the first number (m) may be configured or pre-configured. For example, m equals to the number of symbols for a PSCCH resource used by the first terminal device 110, i.e., legacy PSCCH resource.

In some embodiments, the PSCCH resource comprises a fourth number of RBs in the slot. The fourth number of RBs may start from the lowest RB of each sub-channel. Hereinafter, the fourth number may be represented by s.

In some embodiments, the fourth number(s) may be configured or pre-configured. For example, s equals to the number of RBs for a PSCCH resource used by the first terminal device 110, i.e., legacy PSCCH resource.

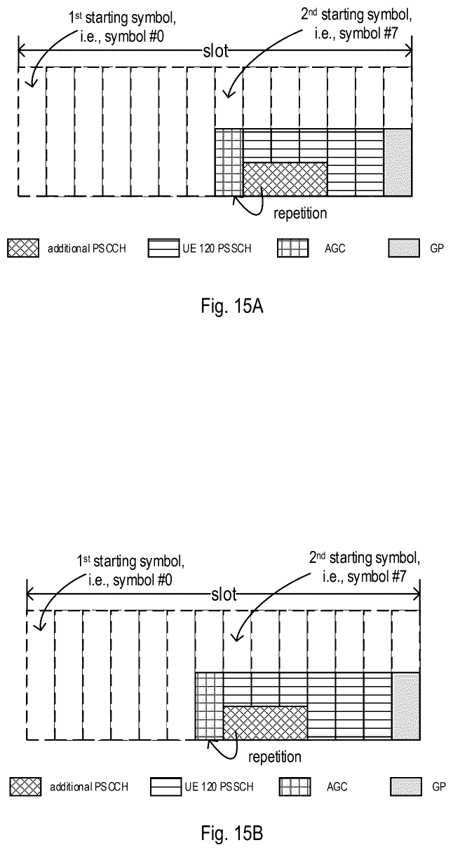

FIGS. 15A and 15B illustrate an example of a PSCCH resource associated with the second start point in accordance with some embodiments of the present disclosure, respectively. In the examples of FIGS. 15A and 15B, M represents the number of symbols for a PSCCH resource associated with the first starting symbol, S represents the number of RBs for a PSCCH resource associated with the first starting symbol, m represents the number of symbols for a PSCCH resource associated with the second starting symbol, and s represents the number of RBs for a PSCCH resource associated with the second starting symbol. m=M=3, and s=S=15. The second start symbol is a symbol #7. The second terminal device 120 uses a PSCCH resource associated with the second start symbol to send SCI format 1 (i.e., the second SCI).

In the example of FIG. 15A, the PSCCH resource associated with the second start symbol (also referred to as “additional PSCCH”) comprises symbols #8 to #10, and a signal on symbol #7 is duplicated from symbol #8.

In the example of FIG. 15B, the PSCCH resource associated with the second start symbol (also referred to as “additional PSCCH”) comprises symbols #7 to #9, and a signal on symbol #6 is duplicated from symbol #7.

The examples of FIGS. 15A and 15B define the PSCCH resource(s) used by the second terminal device 120 and reuse legacy sidelink schemes to indicate sidelink control information by the second terminal device 120.

In some embodiments, the second terminal device 120 may determine a second number of resource elements (REs) allocated for the second sidelink transmission within a physical resource block based on at least one of the following:
the number of subcarriers in the physical resource block,
the number of sidelink symbols in the slot,
an overhead of Physical Sidelink Feedback Channel (PSFCH) resources,
a symbol offset between the first start point and the second start point,
an overhead of Channel-state information Reference Signal (CSI-RS) and Phase-tracking reference signal (PT-RS), or
an overhead of a Demodulation Reference Signal (DM-RS).

For example, the second terminal device 120 may determine the second number of REs as below:

$${N}_{RE}^{′} = {N}_{sc}^{RB} ( {N}_{symb}^{sh} - {N}_{symb}^{PSFCH} - {N}_{add} ) - {N}_{oh}^{PRB} - {N}_{RE}^{DMRS} \qquad ( 1 )$$

$$where :$$

$${N}_{RE}^{′}$$

represents the second number of REs,

$${N}_{sc}^{RB}$$

represents the number of subcarriers in the physical resource block,

$${N}_{symb}^{sh}$$

represents the number of sidelink symbols in the slot,

$${N}_{symb}^{PSFCH}$$

represents the overhead of PSFCH resources,
N_{add}=N₀ or N_{add}=N₀−1 or N_{add}=N₀+1, N₀ represents the symbol offset between the first start point and the second start point,

$${N}_{oh}^{PRB}$$

represents the overhead of other signals, including CSI-RS and PT-RS, and

$${N}_{RE}^{DMRS}$$

represents the overhead of DM-RS.

In turn, the second terminal device 120 may determine a total number of REs allocated for the second sidelink transmission based on the second number of REs.

For example, the second terminal device 120 may determine the total number of REs allocated for the second sidelink transmission as below:

$${N}_{RE} = {N}_{RE}^{′} \cdot {n}_{PRB} - {N}_{RE}^{SCI , 1} - {N}_{RE}^{SCI , 2} \qquad ( 2 )$$

where:
N_{RE} represents the total number of REs used for the second sidelink transmission,

$${N}_{RE}^{′}$$

represents the second number of REs,
n_{PRB} represents the total number of PRBs used for the second sidelink transmission,

$${N}_{R E}^{SCI , 1}$$

represents the total number of REs occupied by the PSCCH resource and DM-RS associated with the second start point,

$${N}_{R E}^{SCI , 2}$$

represents the number or coded modulation symbols generated for second-stage SCI transmission.

Consider an example of determining the total number of REs allocated for the second sidelink transmission. In this example, the first starting symbol is configured as symbol #0, and the second starting symbol is configured as symbol #5. No PSFCH resources are configured in the sidelink resource pool, i.e.,

$${N}_{s y m b}^{P S F C H} = 0 .$$

The second terminal device 120 may determine the total number of REs allocated for the second sidelink transmission (i.e., TB size transmitted on the slot) with the number of available symbols for PSSCH, i.e., N as below:

$$N = ( {N}_{s y m b}^{s h} - {N}_{s y m b}^{PSFCH} - {N}_{a d d} ) = 7$$

$$wherein {N}_{a d d} = {N}_{0} = 5 , {N}_{R E}^{′} and {N}_{R E}$$

can be determined based on equations (1) and (2).
Operation of the First Terminal Device which Transmits from the First Starting Point

As mentioned above, in some embodiments, the second start point is a second start symbol in the slot. In such embodiments, the first terminal device 110 may perform a symbol repetition. This may avoid AGC issue introduced by the second starting symbol.

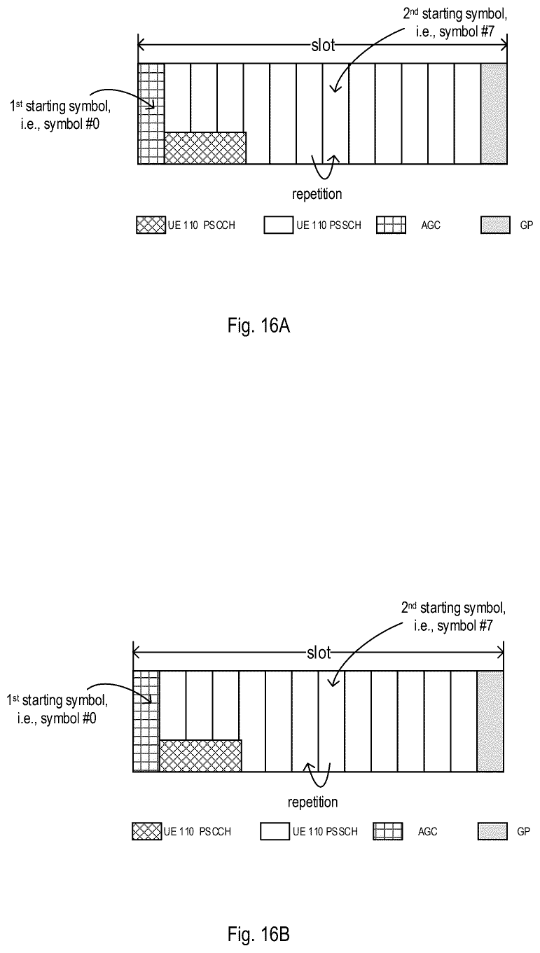

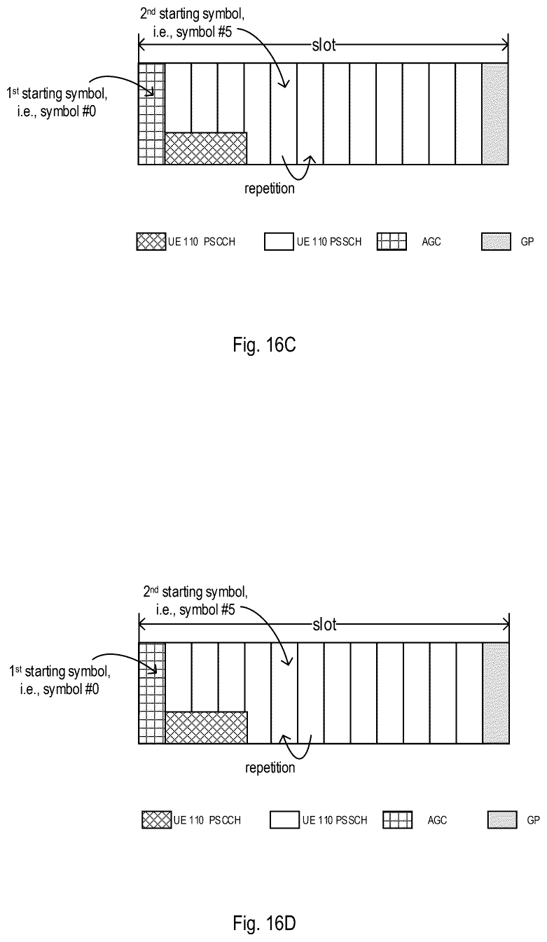

In some embodiments, in order to perform the symbol repetition, the first terminal device 110 may repeat a signal on a third symbol to the second start symbol. The third symbol is immediately before the second start symbol. In case where the second start symbol is a symbol #n and the third symbol is a symbol #n−1, the first terminal device 110 may repeat a signal on the symbol #n−1 to the symbol #n. To “repeat” means that the resource elements used for the PSCCH/PSSCH of the first terminal device 110 on the symbol #n−1, including any DM-RS, PT-RS, or CSI-RS occurring on symbol #n−1, shall be duplicated to symbol #n. This will be described with reference to FIG. 16A.

FIG. 16A illustrates an example of a symbol repetition for the second start symbol in accordance with some embodiments of the present disclosure. In the example of FIG. 16A, two starting symbols are configured or pre-configured in a slot. The first starting symbol is a symbol #0. The second starting symbol is a symbol #7. The first terminal device 110 may repeat the signal on symbol #6 to symbol #7. The second starting symbol is a repetition of the immediately before symbol.

In some embodiments, in order to perform the symbol repetition, the first terminal device 110 may repeat a signal on the second start symbol to the third symbol. The third symbol is immediately before the second start symbol. In case where the second start symbol is a symbol #n and the third symbol is a symbol #n−1, the first terminal device 110 may repeat a signal on the symbol #n to the symbol #n−1. To “repeat” means that the resource elements used for the PSCCH/PSSCH of the first terminal device 110 on the symbol #n, including any DM-RS, PT-RS, or CSI-RS occurring on symbol #n, shall be duplicated in the immediately before symbol #n−1. This will be described with reference to FIG. 16B.

FIG. 16B illustrates an example of a symbol repetition for the second start symbol in accordance with some other embodiments of the present disclosure. In the example of FIG. 16B, two starting symbols are configured or pre-configured in a slot. The first starting symbol is a symbol #0. The second starting symbol is a symbol #7. The first terminal device 110 may repeat the signal on symbol #7 to symbol #6.

In some embodiments, in order to perform the symbol repetition, the first terminal device 110 may repeat the signal on the second start symbol to a fourth symbol immediately after the second start symbol. In case where the second start symbol is a symbol #n and the fourth symbol is a symbol #n+1, the first terminal device 110 may repeat a signal on the symbol #n to the symbol #n+1. To “repeat” means that the resource elements used for the PSCCH/PSSCH the first terminal device 110 on the symbol #n, including any DM-RS, PT-RS, or CSI-RS occurring on symbol #n, shall be duplicated to symbol #n+1. This will be described with reference to FIG. 16C.

FIG. 16C illustrates an example of a symbol repetition for the second start symbol in accordance with still other embodiments of the present disclosure. In the example of FIG. 16C, two starting symbols are configured or pre-configured in a slot. The first starting symbol is a symbol #0. The second starting symbol is a symbol #5. The first terminal device 110 may repeat the signal on symbol #5 to symbol #6. The second starting symbol is duplicated to the next symbol.

In some embodiments, in order to perform the symbol repetition, the first terminal device 110 may repeat a signal on the fourth symbol to the second start symbol. The fourth symbol immediately after the second start symbol. In case where the second start symbol is a symbol #n and the fourth symbol is a symbol #n+1, the first terminal device 110 may repeat a signal on the symbol #n+1 to the symbol #n. To “repeat” means that the resource elements used for the PSCCH/PSSCH the first terminal device 110 on the symbol #n+1, including any DM-RS, PT-RS, or CSI-RS occurring on symbol #n+1, shall be duplicated to symbol #n. This will be described with reference to FIG. 16D.

FIG. 16D illustrates an example of a symbol repetition for the second start symbol in accordance with still other embodiments of the present disclosure. In the example of FIG. 16D, two starting symbols are configured or pre-configured in a slot. The first starting symbol is a symbol #0. The second starting symbol is a symbol #5. The first terminal device 110 may repeat the signal on symbol #6 to symbol #5.

In some embodiments, the first terminal device 110 may transmit SCI on a PSCCH resource associated with the first start point. The SCI may comprise at least one of the following:
the first indication indicating whether the second start point is enabled, or.
the second indication indicating whether a symbol repetition for the second start point is enabled.

In some embodiments, the SCI may use SCI format 1x or SCI format 2x. For example, an SCI format 1-B may comprise a “Repetition indicator” (i.e., the second indication) and an “additional starting symbol enable” indicator (i.e., the first indication) and as shown in Table 2.

TABLE 2

| SCI content | indicator |
|---|---|
| Repetition indicator | “0” |
| (i.e., the second indication) | |
| additional starting symbol enable | “0” |
| (i.e., the first indication) | |

In Table 2, the overhead of the “Repetition indicator” is 1 bit. If the “Repetition indicator” is set to “1”, a symbol repetition for the second start point is enabled, i.e., the symbol repetition for the second start point is performed by the first terminal device 110. If the “Repetition indicator” is set to “0”, a symbol repetition for the second start point is disabled, i.e., the symbol repetition for the second start point is not performed by the first terminal device 110.

In addition, in Table 2, the overhead of the “additional starting symbol enable” indicator is 1 bit. If the “additional starting symbol enable” indicator is set to “1”, an additional starting symbol can be used by other terminal devices. If the “additional starting symbol enable” indicator is set to “0”, no sidelink transmission is allowed from the additional starting symbol (i.e., the second starting symbol) in the slot.

As shown in Table 2, the first terminal device 110 indicates that the second starting symbol is unavailable, and repetition is not performed for the second starting symbol. This provides flexibility of additional starting symbol processing, depending on requirement and channel status of the first terminal device 110.

As mentioned above, the first terminal device 110 may perform a symbol repetition. If the symbol repetition is performed, it means that the practical number of symbols for the transmission of the first terminal device 110 is changed (minus one). Therefore, the TB size determining of the first terminal device 110 should be modified accordingly.

In some embodiments, the first terminal device 110 may determine a third number of REs allocated for the first sidelink transmission within a physical resource block based on at least one of the following:
the number of subcarriers in the physical resource block,
the number of sidelink symbols in the slot,
an overhead of a PSFCH resource,
an overhead of the second start point in the slot,
an overhead of CSI-RS and PT-RS, or
an overhead of a DM-RS.

For example, the first terminal device 110 may determine the third number of REs as below:

$${N}_{R E}^{″} = {N}_{sc}^{R B} ( {N}_{s y m b}^{s h} - {N}_{s y m b}^{P S F C H} - {N}_{r e p} ) - {N}_{o h}^{P R B} - {N}_{R E}^{D M R S} \qquad ( 3 )$$

$$where$$

$${N}_{R E}^{″}$$

represents the third number of REs,

$${N}_{s c}^{R B}$$

represents the number of subcarriers in the physical resource block,

$${N}_{s y m b}^{s h}$$

represents the number of sidelink symbols in the slot,

$${N}_{s y m b}^{P S F C H}$$

represents the overhead of PSFCH resources,
Nᵣₑₚ=k, when the symbol repetition for the additional starting symbols is performed, k is the number of the additional starting symbols in a slot;

$${N}_{o h}^{P R B}$$

represents the overhead or owner signals, including CSI-RS and PT-RS, and

$${N}_{R E}^{D M R S}$$

represents the overhead of DM-RS.

In turn, the first terminal device 110 may determine a total number of REs allocated for the first sidelink transmission based on the third number of REs. This may ensure sidelink TB size determining scheme is aligned with additional starting symbol allocation and relevant repetition for the additional symbols;

For example, the first terminal device 110 may determine the total number of REs allocated for the first sidelink transmission as below:

$${N}_{R E} = {N}_{R E}^{″} \cdot {n}_{P R B} - {N}_{R E}^{SCI , 1} - {N}_{R E}^{SCI , 2} \qquad ( 4 )$$

where:
N_{RE} represents the total number of REs used for the first sidelink transmission,

$${N}_{R E}^{″}$$

n_{PRB} represents the total number of PRBs used for the first sidelink transmission,

$${N}_{R E}^{SCI , 1}$$

represents the total number of REs occupied by the PSCCH resource and DM-RS associated with the first start point, and

$${N}_{R E}^{SCI , 2}$$

represents the number of coded modulation symbols generated for second-stage SCI transmission.

Consider an example of determining the total number of REs used for the first sidelink transmission. In this example, two starting symbols are configured in a slot, i.e., k=1. SCI format 1-B of the first terminal device 110 indicates that the symbol repetition of the second starting symbol is enabled.

Then, the first terminal device 110 may determine the total number of REs used for the first sidelink transmission in the slot with the number of available symbols for PSSCH, i.e., N as below:

$$N = ( {N}_{s y m b}^{s h} - {N}_{s y m b}^{P S F C H} - {N}_{r e p} ) , {N}_{r e p} = 1$$

$$wherein {N}_{R E}^{″} and {N}_{RE}$$

can be determined based on equations (3) and (4).

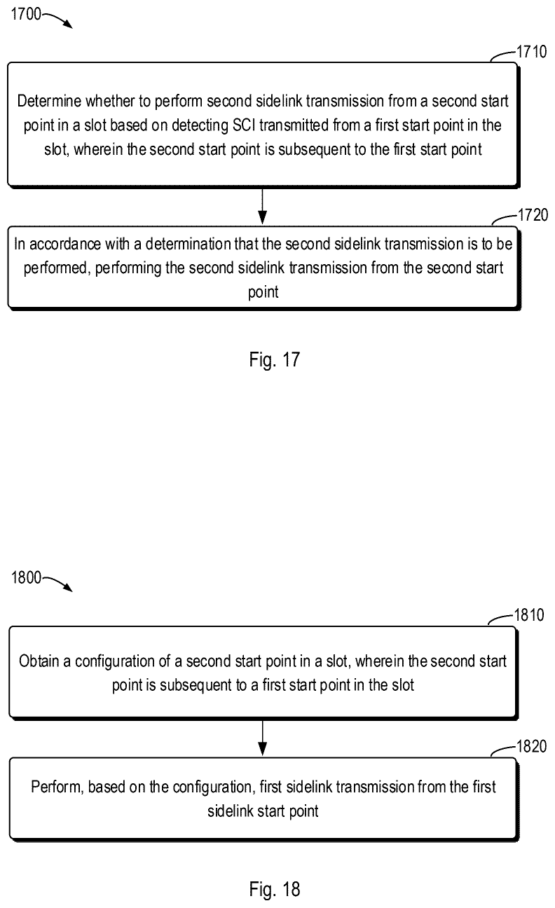

FIG. 17 illustrates a flowchart of an example method in accordance with some embodiments of the present disclosure. In some embodiments, the method 1700 can be implemented at a communication device, such as one of the first terminal device 110, the second terminal device 120 and the third terminal device 130 as shown in FIG. 1. For the purpose of discussion, the method 1700 will be described with reference to FIG. 1 as performed by the second terminal device 120 without loss of generality.

At block 1710, the second terminal device 120 determines whether to perform second sidelink transmission from a second start point in a slot based on detecting SCI transmitted from a first start point in the slot. The second start point is subsequent to the first start point.

At block 1720, if the second sidelink transmission is to be performed, the second terminal device 120 performs the second sidelink transmission from the second start point.

In some embodiments, determining whether to perform the second sidelink transmission from the second start point comprises: if the SCI transmitted from the first start point is not detected, the second terminal device 120 may determine to perform the second sidelink transmission from the second start point.

In some embodiments, the second terminal device 120 may determine whether to perform the second sidelink transmission from the second start point comprises: if at least one of the SCI transmitted from the first start point is detected and that there are available resources in frequency domain in a sidelink resource pool based on the at least one of the SCI, the second terminal device 120 may determine to perform the second sidelink transmission on at least one of the available resources from the second start point.

In some embodiments, the second terminal device 120 may determine to perform the second sidelink transmission on the at least one of the available resources from the second start point comprises: if the second terminal device 120 is not a target receiving device of first sidelink transmission from a first terminal device 110, and that the first terminal device 110 is not a target receiving device of the second sidelink transmission, the second terminal device 120 may determine to perform the second sidelink transmission on the at least one of the available resources from the second start point.

In some embodiments, the second terminal device 120 may determine to perform the second sidelink transmission on the at least one of the available resources from the second start point comprises: if a second priority of the second sidelink transmission is equal to or higher than a first priority of first sidelink transmission from a first terminal device 110, the second terminal device 120 may determine to perform the second sidelink transmission on the at least one of the available resources from the second start point.

In some embodiments, the second terminal device 120 may determine to perform the second sidelink transmission on the at least one of the available resources from the second start point comprises: if a second priority of the second sidelink transmission is equal to or higher than a priority threshold, the second terminal device 120 may determine to perform the second sidelink transmission on the at least one of the available resources from the second start point.

In some embodiments, the second terminal device 120 may determine to perform the second sidelink transmission on the at least one of the available resources from the second start point comprises: if a first ratio is equal to or higher than a first ratio threshold, the second terminal device 120 may determine to perform the second sidelink transmission on the at least one of the available resources from the second start point. In some embodiments, the first ratio is equal to the number of the available resources divided by the number of resources in frequency domain in the sidelink resource pool.

In some embodiments, the second terminal device 120 may determine to perform the second sidelink transmission on the at least one of the available resources from the second start point comprises: if a second ratio is equal to or higher than the second ratio threshold, the second terminal device 120 may determine to perform the second sidelink transmission on the at least one of the available resources from the second start point. In some embodiments, the second ratio is equal to the number of the available resources divided by the number of occupied resources in frequency domain in the sidelink resource pool.

In some embodiments, the second terminal device 120 may determine to perform the second sidelink transmission on the at least one of the available resources from the second start point comprises: if a third ratio is equal to or less than the third ratio threshold, the second terminal device 120 may determine to perform the second sidelink transmission on the at least one of the available resources from the second start point, In some embodiments, the third ratio is equal to the number of the occupied resources divided by the number of resources in frequency domain in the sidelink resource pool.

In some embodiments, first SCI among the at least one of the SCI comprises a first indication indicating whether the second start point is enabled.

In some embodiments, the second terminal device 120 may determine to perform the second sidelink transmission on the at least one of the available resources from the second start point comprises: if the first indication indicates that the second start point is enabled, the second terminal device 120 may determine to perform the second sidelink transmission on the at least one of the available resources from the second start point.

In some embodiments, the second start point is a second start symbol in the slot.

In some embodiments, performing the second sidelink transmission from the second start point comprises: performing a symbol repetition for the second start symbol.

In some embodiments, performing the symbol repetition for the second start symbol comprises at least one of the following: repeating a signal on the second start symbol to a third symbol immediately before the second start symbol, or repeating a signal on a fourth symbol immediately after the second start symbol to the second start symbol.

In some embodiments, performing the second sidelink transmission from the second start point comprises: transmitting an extension signal on a third symbol immediately before the second start symbol.

In some embodiments, a duration of the extension signal is determined based on at least one of the following:
a configuration,
a pre-configuration,
a type of a channel access procedure used by the second terminal device 120,
a duration of the second start symbol, or.
a time gap related to the channel access procedure.

In some embodiments, performing the second sidelink transmission from the second start point comprises: transmitting second SCI on a Physical Sidelink Control Channel (PSCCH) resource associated with the second start point.

In some embodiments, the PSCCH resource comprises a first number of consecutive symbols in the slot. In some embodiments, the first number of consecutive symbols starts from the second start point. In some embodiments, the first number of consecutive symbols starts from a fourth symbol immediately after the second start point.

In some embodiments, performing the second sidelink transmission from the second start point comprises: determining a second number of resource elements allocated for the second sidelink transmission within a physical resource block based on at least one of the following:
the number of subcarriers in the physical resource block,
the number of sidelink symbols in the slot,
an overhead of Physical Sidelink Feedback Channel (PSFCH) resources,
a symbol offset between the first start point and the second start point,
an overhead of Channel-state information Reference Signal and Phase-tracking reference signal, or
an overhead of a Demodulation Reference Signal; and

In such embodiments, performing the second sidelink transmission from the second start point comprises: determining a total number of resource elements allocated for the second sidelink transmission based on the second number of resource elements.

In some embodiments, the second terminal device 120 may determine whether to perform the second sidelink transmission based on a configuration.

In some embodiments, the configuration comprises at least one of the following:
a symbol index of the second start point,
a symbol offset between the first start point and the second start point,
a first indication indicating whether the second start point is enabled,
a second indication indicating whether a symbol repetition for the second start point is enabled,
a third indication that the second start point is not used in the slot which comprises a Physical Sidelink Feedback Channel (PSFCH) resource,
a priority threshold associated with the second start point,
a Channel Access Priority Class (CAPC) threshold associated with the second start point,
a first ratio threshold associated with the second start point,
a second ratio threshold associated with the second start point,
a third ratio threshold associated with the second start point,
a duration of an extension signal associated with the second start point, or
a first number of consecutive symbols in the slot for transmission of second SCI by the second terminal device.

FIG. 18 illustrates a flowchart of an example method in accordance with some embodiments of the present disclosure. In some embodiments, the method 1800 can be implemented at a communication device, such as one of the first terminal device 110, the second terminal device 120 and the third terminal device 130 as shown in FIG. 1. For the purpose of discussion, the method 1800 will be described with reference to FIG. 1 as performed by the first terminal device 110 without loss of generality.

At block 1810, the first terminal device 110 obtains a configuration of a second start point in a slot. The second start point is subsequent to a first start point in the slot.

At block 1820, the first terminal device 110 performs, based on the configuration, first sidelink transmission from the first sidelink start point.

In some embodiments, the configuration comprises at least one of the following:
a symbol index of the second start point,
a symbol offset between the first start point and the second start point,
a first indication indicating whether the second start point is enabled,
a second indication indicating whether a symbol repetition for the second start point is enabled,
a third indication that the second start point is not used in the slot which comprises a Physical Sidelink Feedback Channel (PSFCH) resource,
a priority threshold associated with the second start point,
a Channel Access Priority Class (CAPC) threshold associated with the second start point,
a first ratio threshold associated with the second start point,
a second ratio threshold associated with the second start point,
a third ratio threshold associated with the second start point,
a duration of an extension signal associated with the second start point, or
a first number of consecutive symbols in the slot for transmission of second SCI by the second terminal device.

In some embodiments, the second start point is a second start symbol in the slot.

In some embodiments, performing the first sidelink transmission comprises: performing a symbol repetition. Performing a symbol repetition comprises at least one of the following:
repeating a signal on a third symbol to the second start symbol, the third symbol being immediately before the second start symbol,
repeating a signal on the second start symbol to the third symbol,
repeating the signal on the second start symbol to a fourth symbol immediately after the second start symbol, or
repeating a signal on the fourth symbol to the second start symbol.

In some embodiments, performing the first sidelink transmission from the first start point comprises: transmitting SCI on a Physical Sidelink Control Channel (PSCCH) resource associated with the first start point. In some embodiments, the SCI comprises at least one of the following: a first indication indicating whether the second start point is enabled, or a second indication indicating whether a symbol repetition for the second start point is enabled.

In some embodiments, performing the first sidelink transmission comprises: determining a third number of resource elements allocated for the first sidelink transmission within a physical resource block based on at least one of the following:
the number of subcarriers in the physical resource block,
the number of sidelink symbols in the slot,
an overhead of a Physical Sidelink Feedback Channel (PSFCH) resource,
an overhead of the second start point in the slot,
an overhead of Channel-state information Reference Signal and Phase-tracking reference signal, or
an overhead of a Demodulation Reference Signal; and

In such embodiments, performing the first sidelink transmission comprises: determining a total number of resource elements allocated for the first sidelink transmission based on the third number of resource elements.

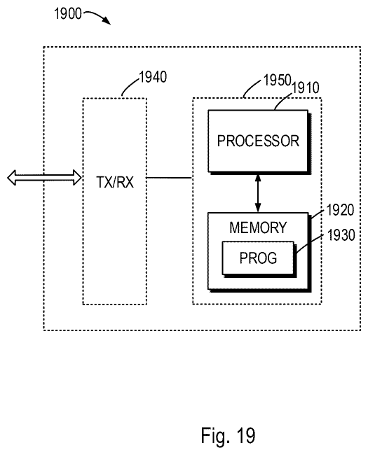

FIG. 19 is a simplified block diagram of a device 1900 that is suitable for implementing some embodiments of the present disclosure. The device 1900 can be considered as a further example embodiment of one of the terminal devices 110, 120 and 130, or one of the network devices 140 and 150 as shown in FIG. 1. Accordingly, the device 1900 can be implemented at or as at least a part of one of the terminal devices 110, 120 and 130, or one of the network devices 140 and 150.

As shown, the device 1900 includes a processor 1910, a memory 1920 coupled to the processor 1910, a suitable transmitter (TX) and receiver (RX) 1940 coupled to the processor 1910, and a communication interface coupled to the TX/RX 1940. The memory 1920 stores at least a part of a program 1930. The TX/RX 1940 is for bidirectional communications. The TX/RX 1940 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1930 is assumed to include program instructions that, when executed by the associated processor 1910, enable the device 1900 to operate in accordance with the embodiments of the present disclosure, as discussed herein with reference to FIGS. 1 to 18. The embodiments herein may be implemented by computer software executable by the processor 1910 of the device 1900, or by hardware, or by a combination of software and hardware. The processor 1910 may be configured to implement various embodiments of the present disclosure. Furthermore, a combination of the processor 1910 and memory 1920 may form processing means 1950 adapted to implement various embodiments of the present disclosure.

The memory 1920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1920 is shown in the device 1900, there may be several physically distinct memory modules in the device 1900. The processor 1910 may be of any type suitable to the local technical network, and may include one or more of general purpose computers, special purpose computers, microprocessors, digital signal processors (DSPs) and processors based on multicore processor architecture, as non-limiting examples. The device 1900 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

1-20. (canceled)

21. A method performed by a terminal device, comprising:
receiving configuration information comprising location of a second starting symbol within a slot, wherein the second starting symbol is the second of two starting symbols within the slot; and
performing a Physical Sidelink Control Channel (PSCCH) transmission,
wherein resource elements used for the PSCCH transmission in a symbol immediately after the second starting symbol are duplicated in the second starting symbol.

22. The method of claim 21, wherein the resource elements including any Demodulation Reference Signal (DM-RS), Phase-tracking reference signal (PT-RS), or Channel-state information Reference Signal (CSI-RS) occurring in the symbol immediately after the second starting symbol are duplicated.

23. The method of claim 21, wherein the second starting symbol is not used in the slot which comprises a Physical Sidelink Feedback Channel (PSFCH) resource.

24. The method of claim 21, wherein the second starting symbol is symbol #5 or a symbol #7.

25. A terminal device, comprising a processor configured to:
receive configuration information comprising location of a second starting symbol within a slot, wherein the second starting symbol is the second of two starting symbols within the slot; and
perform a Physical Sidelink Control Channel (PSCCH) transmission,
wherein resource elements used for the PSCCH transmission in a symbol immediately after the second starting symbol are duplicated in the second starting symbol.

26. The terminal device of claim 25, wherein the resource elements including any Demodulation Reference Signal (DM-RS), Phase-tracking reference signal (PT-RS), or Channel-state information Reference Signal (CSI-RS) occurring in the symbol immediately after the second starting symbol are duplicated.

27. The terminal device of claim 25, wherein the second starting symbol is not used in the slot which comprises a Physical Sidelink Feedback Channel (PSFCH) resource.

28. The terminal device of claim 25, wherein the second starting symbol is symbol #5 or a symbol #7.
